(19) United States
(12) Patent Application Publication
(10) Pub. No.: US 2012/0160093 A1
(43) Pub. Date: Jun. 28, 2012

(54) AIR CYLINDER

(75) Inventors: Masaru Taniguchi, Tsukubamirai-shi (JP); Jun Yamada, Tsukubamarai-shi (JP)

(73) Assignee: SMC Corporation, Tokyo (JP)

(21) Appl. No.: 13/389,983

(22) PCT Filed: Sep. 11, 2009
(86) PCT No.: PCT/JP2009/065925

§ 371 Date: Feb. 10, 2012

(51) Int. Cl. F16J 15/18

(52) U.S. Cl. 92/165 R

(57) ABSTRACT

An air cylinder having a simple and effective configuration to reduce the axial length and provide ease of processing. A sliding bearing that guides a piston rod is disposed at a position adjacent to a groove in which a rod packing is fitted. One end of the sliding bearing serves as the side wall of the groove and prevents displacement of the rod packing. The other end of the sliding bearing extends so as to cover part of a yenta of a first port. An orifice having a sectional area smaller than that of the yenta is formed at the position of the yenta by the sliding bearing.

### TECHNICAL FIELD

The present invention relates to air cylinders that convert the energy of compressed air into a linear motion and perform various operations.

### BACKGROUND ART

Air cylinders operated by compressed air are extremely common. As schematically shown in FIG. 8, air cylinders have a piston 42 that slides in a cylinder hole 41 in a cylinder body 40, a piston rod 43 that is connected to the piston 42, pressure chambers 44a and 44b that are formed on both sides of the piston 42, and two ports 45a and 45b through which compressed air is supplied to and discharged from the pressure chambers. By alternately supplying and discharging compressed air to and from the pressure chambers 44a and 44b through the ports 45a and 45b, the piston rod 43 is reciprocated with the piston 42 and various operations are performed.

Since a linear motion can be obtained easily, such air cylinders are widely used in various automatic machines. However, in general, air cylinders are often installed in very narrow places or in spaces that are limited by other adjacent devices or the like. Therefore, air cylinders used in such places are required to have an axial length that is reduced even a little without reducing the operating stroke. At the same time, their structures are desired to be as simple as possible, and the processing of them is desired to be as easy as possible.

### SUMMARY OF INVENTION

### Technical Problem

It is an object of the present invention to provide an air cylinder having a simple and effective configuration for reducing the axial length and for providing ease of processing.

### Solution to Problem

To attain the above object, the present invention provides an air cylinder including a cylinder body having a cylinder hole therein, a rod cover and a head cover covering both ends of the cylinder hole, a piston sliding in the cylinder hole, a piston rod that slidably penetrates a rod insertion hole of the rod cover and a proximal end of which is connected to the piston, a first pressure chamber and a second pressure chamber formed on both sides of the piston, a first port and a second port formed in the rod cover and the head cover in order to supply and discharge compressed air to and from the first pressure chamber and the second pressure chamber, a rod packing that seals the gap between the inner periphery of the rod cover and the outer periphery of the piston rod, and a ring-shaped sliding bearing that lies between the inner periphery of the rod cover and the outer periphery of the piston rod and that guides the piston rod.

The first port extends in a direction perpendicular to the axis of the cylinder hole, communicates with a vent that opens on the hole surface of the rod insertion hole, and leads from the vent through a communication channel formed by part of the rod insertion hole to the first pressure chamber.

The rod packing is fitted in a groove formed at a position in the inner periphery of the rod cover closer to a distal end of the piston rod than the vent.

The sliding bearing is disposed so as to be adjacent to the vent side of the groove. One end thereof forms the side wall of the groove, is in contact with the rod packing, and thereby prevents displacement of the rod packing from the groove. The other end thereof extends so as to cover part of the vent, and forms an orifice having a sectional area smaller than that of the vent at the position of the vent.

In the present invention, the rod insertion hole may have a large diameter portion that forms the communication channel and a small diameter portion in which the sliding bearing is fitted, at positions adjacent to each other, and the vent may be provided so as to straddle the boundary between the large diameter portion and the small diameter portion.

According to an embodiment of the present invention, a circular recess is formed in a second piston surface of the piston facing the second pressure chamber concentrically with the piston, a rod attachment hole is formed in the center of the piston, the rod attachment hole includes a uniform hole portion having a uniform internal diameter and a tapered hole portion the internal diameter of which increases gradually toward the second piston surface, an attachment shaft portion of the piston rod having a reduced diameter is fitted in the rod attachment hole, the attachment shaft portion includes a uniform shaft portion having a uniform external diameter and a tapered shaft portion the external diameter of which increases gradually toward the shaft end, the piston rod is connected to the piston by placing a stepped portion at the proximal end of the attachment shaft portion against a first piston surface of the piston facing the first pressure chamber and fitting the tapered shaft portion in the tapered hole portion, and a ring-shaped damper is fitted in the recess, with part thereof protruding from the second piston surface, so as to surround the end portion of the piston rod.

In this case, the inner periphery of the uniform hole portion of the rod attachment hole and the outer periphery of the uniform shaft portion of the piston rod are out of contact with each other owing to the presence of a gap therebetween.

### Advantageous Effects of Invention

The configuration of the present invention is very effective for reducing the axial length of an air cylinder and for providing ease of processing. In particular, causing a sliding bearing that guides a piston rod to extend so as to cover part of a vent of a port and thereby forming an orifice with this sliding bearing are highly effective for reducing the axial length of an air cylinder compared to the case where the sliding bearing and the vent are formed at positions distant from each other in the direction of the axis of the air cylinder. In addition, it is not necessary to form an orifice by reducing the diameter of the vent by processing, and therefore processing of a port and formation of an orifice are easy.

### BRIEF DESCRIPTION OF DRAWINGS

FIG. 1 is a side view showing a first embodiment of the present invention.

FIG. 2 is a front view of FIG. 1 as viewed from the left side thereof.

FIG. 3 is a sectional view of FIG. 1.

FIG. 4 is a partial sectional view showing a second embodiment of the present invention.

FIG. 5 is a sectional view showing a third embodiment of the present invention.

FIG. 6 is a side view showing a fourth embodiment of the present invention.

FIG. 7 is a sectional view of FIG. 6.

FIG. 8 is a sectional view schematically showing a known cylinder.

### DESCRIPTION OF EMBODIMENTS

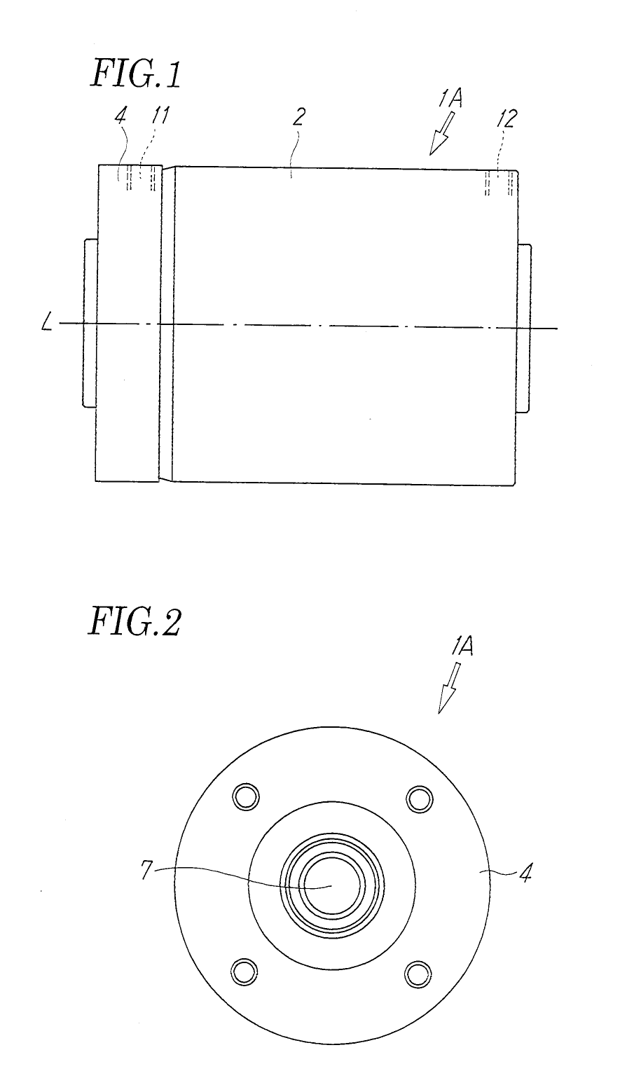

FIGS. 1 to 3 disclose a first embodiment of an air cylinder according to the present invention. This air cylinder 1A has a cylindrical cylinder body 2 that has a circular cylinder hole 3 therein, a circular rod cover 4 and a circular head cover 5 that cover both ends of the cylinder hole 3, a piston 6 that slides in the cylinder hole 3 in the direction of axis L, and a piston rod 7 a proximal end of which is connected to the piston 6 and that slidably penetrates the rod cover 4. In addition, this air cylinder 1A has a first pressure chamber 8 formed between the piston 6 and the rod cover 4, a second pressure chamber 9 formed between the piston 6 and the head cover 5, and a first port 11 and a second port 12 formed in the rod cover 4 and the head cover 5, respectively, in order to supply and discharge compressed air to and from the first pressure chamber 8 and the second pressure chamber 9. In the figure, reference sign 10 denotes a piston packing attached to the outer periphery of the piston 6.

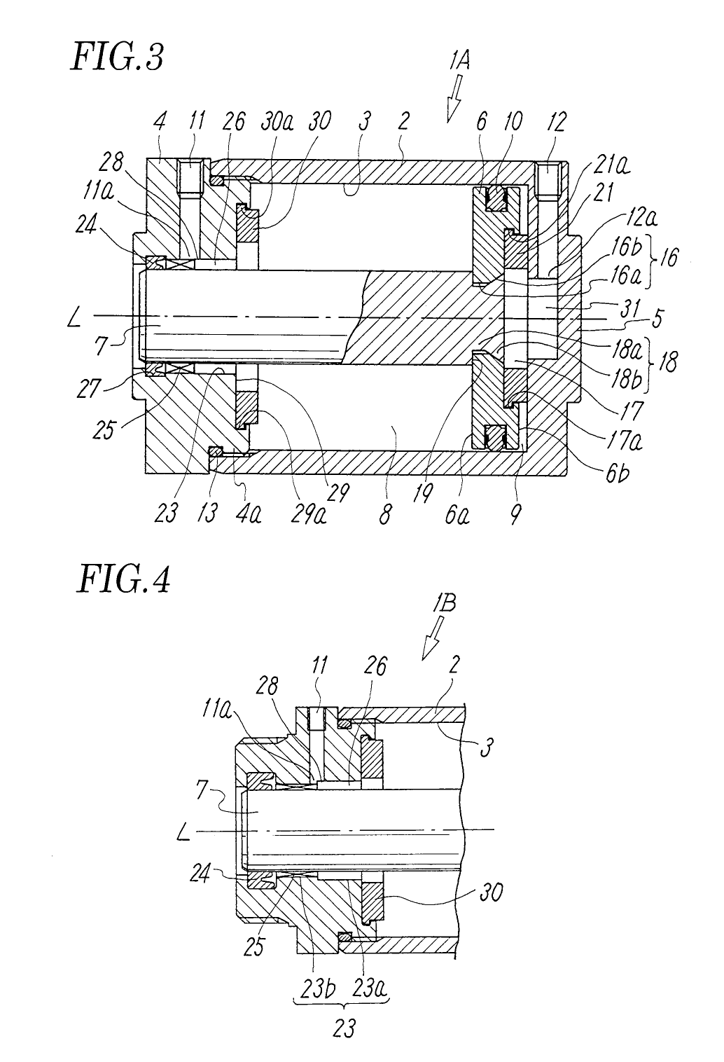

When compressed air is supplied through the first port 11 into the first pressure chamber 8 and the air in the second pressure chamber 9 is discharged through the second port 12 to the outside, the piston 6 and the piston rod 7 move to the backward stroke end shown in FIG. 3. Reversely, when compressed air is supplied through the second port 12 into the second pressure chamber 9 and the air in the first pressure chamber 8 is discharged through the first port 11 to the outside, the piston 6 and the piston rod 7 move to the forward stroke end on the side opposite to FIG. 3.

The cylinder body 2 and the head cover 5 are integrally formed of aluminum alloy. The rod cover 4 made of aluminum alloy is attached to the open end of the cylinder body 2. The attachment of the rod cover 4 is performed by screwing a male screw thread formed on the outer periphery of an attachment portion 4a of the rod cover 4 into a female screw thread formed in the inner periphery of the cylinder body 2.

The FIG. 13 denotes a tube gasket provided between the outer periphery of the attachment portion 4a of the rod cover 4 and the inner periphery of the cylinder body 2.

The piston rod 7 is formed of hard metal such as carbon steel. This is attached to the piston 6 made of aluminum alloy by caulking. For this purpose, a rod attachment hole 16 penetrating the center of the piston 6 is formed in the piston 6. The rod attachment hole 16 includes a uniform hole portion 16a having a uniform internal diameter and a tapered hole portion 16b the internal diameter of which increases gradually toward the hole end. The uniform hole portion 16a occupies a position close to a first piston surface 6a of the piston 6, and the tapered hole portion 16b occupies a position close to a second piston surface 6b of the piston 6 in which a recess 17 is formed. The first piston surface 6a of the piston 6 means the surface facing the first pressure chamber 8, and the second piston surface 6b means the surface facing the second pressure chamber 9.

On the other hand, an attachment shaft portion 18 having a reduced diameter is formed at the proximal end of the piston rod 7. The attachment shaft portion 18 is inserted into the rod attachment hole 16. With a stepped portion 19 at one end side (the proximal end side) of the attachment shaft portion 18 being placed against the first piston surface 6a of the piston 6, the other end side (the distal end side) of the attachment shaft portion 18 is deformed by caulking so as to taper. Thereby, a uniform shaft portion 18a having a uniform external diameter, and a tapered shaft portion 18b the external diameter of which increases gradually toward the shaft end are formed in the attachment shaft portion 18. The uniform shaft portion 18a fits in the uniform hole portion 16a of the rod attachment hole 16, and the tapered shaft portion 18b fits in the tapered hole portion 16b of the rod attachment hole 16. By holding the piston 6 between the tapered shaft portion 18b and the stepped portion 19, the piston rod 7 is fixed to the piston 6.

The external diameter of the uniform shaft portion 18a is slightly smaller than the internal diameter of the uniform hole portion 16a of the rod attachment hole 16, and therefore the outer periphery of the uniform shaft portion 18a and the inner periphery of the uniform hole portion 16a are out of contact with each other owing to the presence of a gap therebetween.

The end face of the tapered shaft portion 18b is located at about the same position as the bottom surface of the recess 17, and at least does not protrude outward from the second piston surface 6b of the piston 6. The seal between the piston 6 and the piston rod 7 is ensured by contact between the tapered shaft portion 18b and the tapered hole portion 16b.

Since the piston 6 and the piston rod 7 are connected in this manner, a nut attachment portion does not protrude from the piston 6 as in the case where the piston 6 and the piston rod 7 are connected with a nut. Therefore, the axial length of the air cylinder 1A can be reduced, and this leads to simplification of the structure and weight saving.

The circular recess 17 is formed in the second piston surface 6b of the piston 6 concentrically with the piston 6. A ring-shaped head-side damper 21 made of urethane resin is fitted in the recess 17, with the distal end thereof protruding from the second piston surface 6b into the second pressure chamber 9, so as to surround the end portion of the piston rod 7. The attachment thereof is performed by fitting and engaging a ring-shaped engaging protrusion 21a formed on the outer periphery of the proximal end of the damper 21 into and with a ring-shaped engaging groove 17a formed in the inner periphery of the recess 17 close to the bottom of the recess 17. When the piston 6 moves to the backward stroke end of FIG. 3, the damper 21 comes into contact with the head cover 5 and absorbs impact and noise.

In addition to the first port 11, the rod cover 4 has a rod insertion hole 23 into which the piston rod 7 is inserted. In the rod insertion hole 23, a rod packing 24 that seals the gap between the inner periphery of the rod cover 4 and the outer periphery of the piston rod 7 and that has a unidirectional lip shape, and a ring-shaped sliding bearing 25 that lies between the inner periphery of the rod cover 4 and the outer periphery of the piston rod 7 and that guides the piston rod 7, are provided.

The first port 11 extends straight from the upper surface of the rod cover 4 in a direction perpendicular to the axis L of the cylinder hole 3 while keeping a uniform hole diameter, communicates with a vent 11a that opens on the hole surface of the rod insertion hole 23, and leads from the vent 11a through a ring-shaped communication channel 26 formed by part of the rod insertion hole 23 to the first pressure chamber 8. The vent 11a is part of the first port 11, and therefore the diameter of the vent 11a is the same as the diameter of the first port 11.

The entrance end of the first port 11 is a pipe connection portion in the inner periphery of which a female screw thread is cut in order to directly connect an air pipe by screwing. However, in order to connect an air pipe via a pipe joint, the entrance end of the first port 11 may be configured such that the pipe joint can be attached.

The rod packing 24 is fitted in a groove 27 formed in the inner periphery of the rod cover 4 with the lips facing the first pressure chamber 8. The groove 27 is formed at a position closer to the distal end of the piston rod 7 than the vent 11a.

The sliding bearing 25 is formed of sintered alloy in a short cylinder shape having a uniform thickness, and its sliding property is increased by oil impregnation. The sliding bearing 25 is press fitted in and fixed to the rod insertion hole 23 so as to be adjacent to the vent 11a side of the groove 27. One end of the sliding bearing 25 forms part of the side wall of the groove 27, is in contact with the rod packing 24, and prevents the rod packing 24 from being drawn into the gap between the piston rod 7 and the rod cover 4 during the backward stroke of the piston rod 7. The other end of the sliding bearing 25 extends so as to cover part of the vent 11a and forms an orifice 28 having a sectional area smaller than that of the vent 11a at the position of the vent 11a. Therefore, the sliding bearing 25 serves as a displacement preventing member that prevents displacement of the rod packing 24 from the groove 27, and an orifice forming member that forms the orifice 28 at the position of the vent 11a.

The orifice 28 sets the maximum operation speed of the piston rod 7 to a safe speed by limiting the flow rate of air. Through the orifice 28, compressed air from the first port 11 is supplied to the first pressure chamber 8, and air from the first pressure chamber 8 is discharged to the first port 11.

By disposing the sliding bearing 25 and the vent 11a of the first port 11 in such a positional relationship, the axial length of the air cylinder 1A can be reduced compared to the case where the sliding bearing 25 and the vent 11a are formed at positions distant from each other in the direction of axis L. In addition, it is not necessary to form the orifice 28 by processing, for example, reducing the diameter of the first port 11 in the portion of the vent 11a, and therefore processing of the port and formation of the orifice 28 are facilitated.

A circular recess 29 is formed in the inner surface of the rod cover 4 facing the first pressure chamber 8 concentrically with the rod insertion hole 23. A ring-shaped rod-side damper 30 made of urethane resin is fitted in the recess 29, with the distal end thereof protruding into the first pressure chamber 8, so as to surround the rod insertion hole 23. The attachment thereof is performed by fitting and engaging a ring-shaped engaging protrusion 30a formed on the outer periphery of the proximal end of the damper 30 into and with a ring-shaped engaging groove 29a formed in the inner periphery of the recess 29 close to the bottom of the recess 29. When the piston 6 moves from the backward stroke end of FIG. 1 to the forward stroke end, the damper 30 comes into contact with the piston 6 and absorbs impact and noise.

On the other hand, in addition to the second port 12, the head cover 5 has a circular auxiliary chamber 31 communicating with the second pressure chamber 9 in the center of the inner surface thereof. The second port 12 extends straight from the upper surface of the head cover 5 in a direction perpendicular to the axis L of the cylinder hole 3 while keeping a uniform hole diameter. A vent 12a at the lower end opens into the auxiliary chamber 31. The second port 12 communicates with the second pressure chamber 9 through the auxiliary chamber 31. As with the first port 11, the entrance end of the second port 12 is a pipe connection portion for directly connecting an air pipe by screwing. However, the entrance end of the second port 12 may be configured such that a pipe joint can be attached.

In the first embodiment, the portion of the rod insertion hole 23 to which the sliding bearing 25 is attached has the same hole diameter as the portion of the communication channel 26. However, the portions may have different hole diameters as in an air cylinder 1B of a second embodiment shown in FIG. 4.

That is to say, in the second embodiment, the rod insertion hole 23 has a large diameter portion 23a that forms the communication channel 26 and that has a large hole diameter, and a small diameter portion 23b in which the sliding bearing 25 is fitted and that has a small hole diameter, at positions adjacent to each other, and the vent 11a is provided so as to straddle the boundary between the large diameter portion 23a and the small diameter portion 23b.

By configuring as above, the opening area of the orifice 28 can be adjusted to the necessary size by the diameter difference between the large diameter portion 23a and the small diameter portion 23b in the case where it is difficult to ensure a sufficient opening area of the orifice 28 because the thickness of the sliding bearing 25 is small or the degree of overlapping between the vent 11a and the sliding bearing 25 is high.

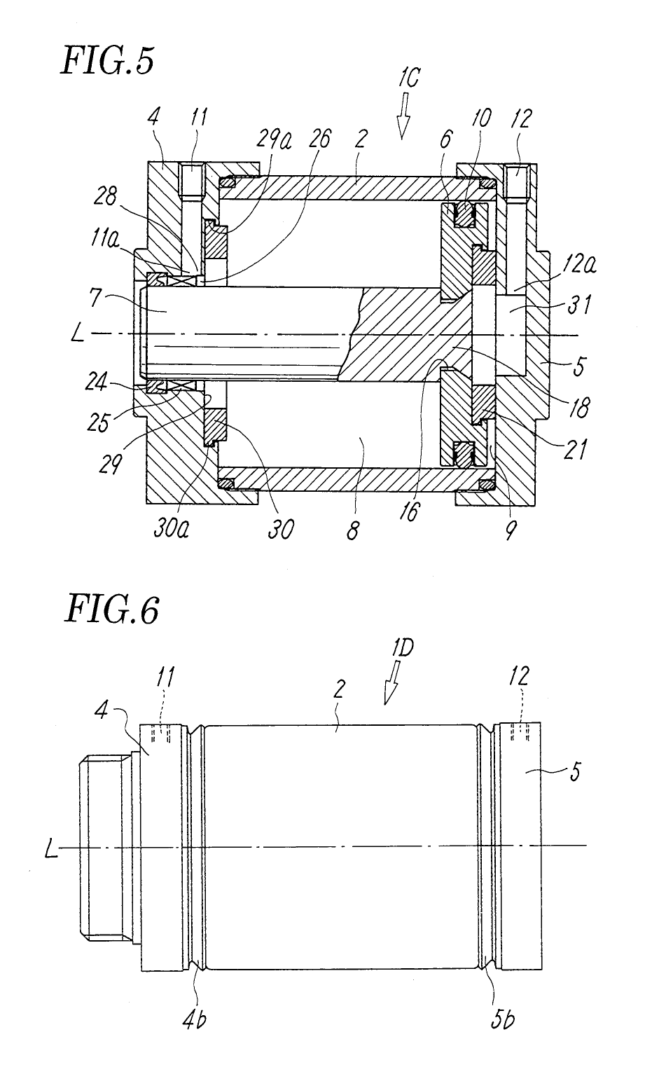

FIG. 5 discloses a third embodiment of the present invention. The air cylinder 1C of the third embodiment differs from the air cylinder 1A of the first embodiment in that the head cover 5 is formed separately from the cylinder body 2 and is joined to the cylinder body 2. The air cylinder 1C of the third embodiment differs from the air cylinder 1A of the first embodiment differs also in that male screw threads are formed on the outer peripheries of both ends of the cylinder body 2, and these are screwed into female screw threads formed in the inner peripheries of the rod cover 4 and the head cover 5.

However, except for the above-described respects, the third embodiment is substantially the same as the first embodiment. So, the same reference signs will be used to designate the same main components as those in the first embodiment, and the description thereof will be omitted.

In the air cylinder 1C of the third embodiment, in the vent 11a, the portion of the rod insertion hole 23 in which the sliding bearing 25 is provided and the portion of the communication channel 26 may have different hole diameters as in the second embodiment.

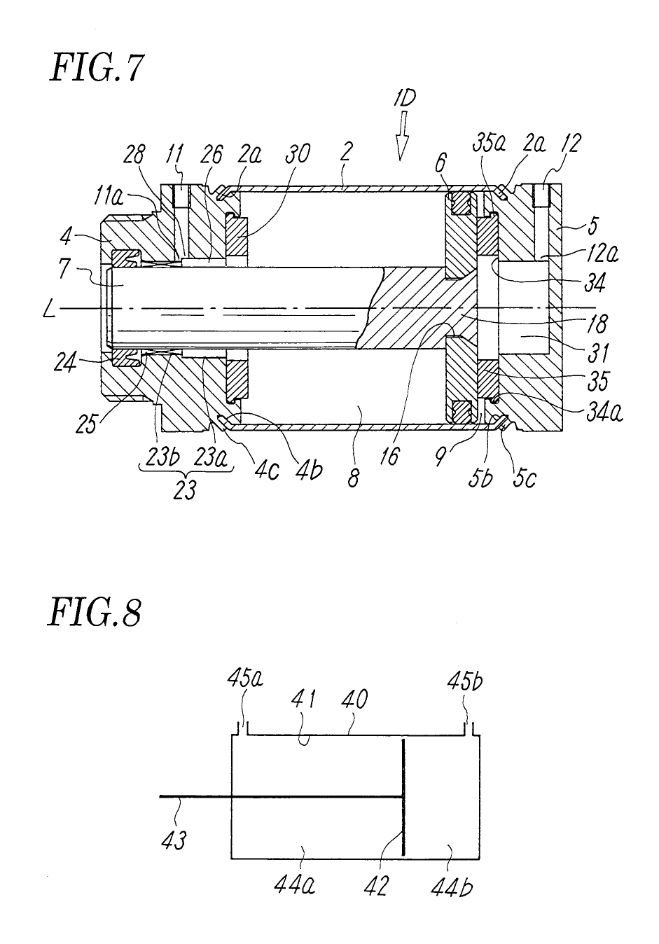

FIGS. 6 and 7 discloses a fourth embodiment of the present invention. The air cylinder 1D of the fourth embodiment differs from the first and third embodiments in that the cylinder body 2 is formed separately from the rod cover 4 and the head cover 5 and is joined to the rod cover 4 and the head cover 5 by crimping. The air cylinder 1D of the fourth embodiment differs from the first and third embodiments also in that the head-side damper 21 is attached to the inner surface of the head cover 5 instead of the piston 6. In addition, as in the second embodiment, the portion of the rod insertion hole 23 to which the sliding bearing 25 is attached and the portion of the communication channel 26 have different hole diameters. However, the portions may have the same hole diameter as in the first embodiment.

The cylinder body 2 is made of stainless steel. Short cylindrical connecting portions of the rod cover 4 and the head cover 5 made of aluminum alloy are inserted into both ends of the cylinder body 2, and both ends of the cylinder body 2 are squeezed so as to taper outward. Inclined portions 2a at the ends of the cylinder body 2 engage with inclined surfaces 4b and 5b of the rod cover 4 and the head cover 5 and are held between the inclined surfaces 4b and 5b and the holding portions 4c and 5c. Thereby, the cylinder body 2, the rod cover 4, and the head cover 5 are joined in an airtight manner.

A circular recess 34 having a diameter larger than that of the auxiliary chamber 31 is formed in the inner surface of the head cover 5 facing the second pressure chamber 9 concentrically with the head cover 5. A ring-shaped damper 35 made of urethane resin is fitted in the recess 34, with the distal end thereof protruding into the second pressure chamber 9. As with the attachment of the damper 30 in the rod cover 4, the attachment of the damper 35 is performed by fitting and engaging a ring-shaped engaging protrusion 35a formed on the outer periphery of the proximal end of the damper 35 into and with a ring-shaped engaging groove 34a formed in the inner periphery of the recess 34 close to the bottom of the recess 34.

However, as in the first embodiment, the damper 35 may be attached to the piston 6.

Except for the above-described respects, the fourth embodiment is substantially the same as the first embodiment. So, the same reference signs will be used to designate the same main components as those in the first embodiment, and the description thereof will be omitted.

In the first to third embodiments, the head-side damper 21 attached to the piston 6 may be attached to the head cover 5 as in the fourth embodiment.

### EXPLANATION OF REFERENCE

1A, 1B, 1C, 1D AIR CYLINDER
2 CYLINDER BODY
3 CYLINDER HOLE
4 ROD COVER
5 HEAD COVER
6 PISTON
6a FIRST PISTON SURFACE
6b SECOND PISTON SURFACE
7 PISTON ROD
8 FIRST PRESSURE CHAMBER
9 SECOND PRESSURE CHAMBER
11 FIRST PORT
11a VENT
12 SECOND PORT
12a VENT
16 ROD ATTACHMENT HOLE
16a UNIFORM HOLE PORTION
16b TAPERED HOLE PORTION
17 RECESS
18 ATTACHMENT SHAFT PORTION
18a UNIFORM SHAFT PORTION
18b TAPERED SHAFT PORTION
19 STEPPED PORTION
21 DAMPER
23 ROD INSERTION HOLE
23a LARGE DIAMETER PORTION
23b SMALL DIAMETER PORTION
24 ROD PACKING
25 SLIDING BEARING
26 COMMUNICATION CHANNEL
27 GROOVE
28 ORIFICE
L AXIS

1-4. (canceled)

5. An air cylinder comprising:
a cylinder body having a cylinder hole therein;
a rod cover and a head cover covering both ends of the cylinder hole;
a piston sliding in the cylinder hole;
a piston rod that slidably penetrates a rod insertion hole of the rod cover and a proximal end of which is connected to the piston;
a first pressure chamber and a second pressure chamber formed on both sides of the piston;
a first port and a second port formed in the rod cover and the head cover in order to supply and discharge compressed air to and from the first pressure chamber and the second pressure chamber;
a rod packing that seals the gap between the inner periphery of the rod cover and the outer periphery of the piston rod; and
a ring-shaped sliding bearing that lies between the inner periphery of the rod cover and the outer periphery of the piston rod and that guides the piston rod,
wherein the piston includes a first piston surface facing the first pressure chamber and a second piston surface facing the second pressure chamber,
a rod attachment hole is formed in the center of the piston, the rod attachment hole includes a uniform hole portion having a uniform internal diameter and a tapered hole portion having an internal diameter which increases gradually toward the second piston surface,
an attachment shaft portion of the piston rod having a reduced diameter is fitted in the rod attachment hole, the attachment shaft portion includes a uniform shaft portion having a uniform external diameter and a tapered shaft portion having an external diameter which increases gradually toward the shaft end, the piston rod is connected to the piston by placing a stepped portion at the proximal end side of the attachment shaft portion against the first piston surface and engaging the tapered shaft portion with the tapered hole portion, and the inner periphery of the uniform hole portion and the outer periphery of the uniform shaft portion are out of contact with each other owing to the presence of a gap therebetween.

6. The air cylinder according to claim 5, wherein the first port extends in a direction perpendicular to the axis of the cylinder hole, communicates with a vent that opens on the hole surface of the rod insertion hole, and leads from the vent through a communication channel formed by part of the rod insertion hole to the first pressure chamber,
the rod packing is fitted in a groove formed at a position in the inner periphery of the rod cover closer to the distal end of the piston rod than the vent,
the sliding bearing is disposed so as to be adjacent to the groove at the vent side, one end thereof forms the side wall of the groove, is in contact with the rod packing, and thereby prevents displacement of the rod packing from the groove, and the other end thereof extends so as to cover part of the vent, and forms an orifice having a sectional area smaller than that of the vent at the position of the vent.

7. The air cylinder according to claim 6, wherein the rod insertion hole has a large diameter portion that forms the communication channel and a small diameter portion in which the sliding bearing is fitted, at positions adjacent to each other, and the vent is provided so as to straddle the boundary between the large diameter portion and the small diameter portion.

8. The air cylinder according to claim 5, wherein a circular recess is formed in the second piston surface of the piston concentrically with the piston, and a ring-like damper is fitted in the recess, with part thereof protruding from the second piston surface, so as to surround the end portion of the piston rod.

9. The air cylinder according to claim 6, wherein a circular recess is formed in the second piston surface of the piston concentrically with the piston, and a ring-like damper is fitted in the recess, with part thereof protruding from the second piston surface, so as to surround the end portion of the piston rod.

10. The air cylinder according to claim 7, wherein a circular recess is formed in the second piston surface of the piston concentrically with the piston, and a ring-like damper is fitted in the recess, with part thereof protruding from the second piston surface, so as to surround the end portion of the piston rod.
